(19) United States
(12) Patent Application Publication
(10) Pub. No.: US 2006/0184702 A1
(43) Pub. Date: Aug. 17, 2006

(54) Apparatus and related method for sharing address and data pins of a cryptocard module and external memory

(76) Inventor: You-Min Yeh, Chi-Lung City (TW)

Correspondence Address: NORTH AMERICA INTELLECTUAL PROPERTY CORPORATION, P.O. BOX 506, MERRIFIELD, VA, 22116, US

(21) Appl. No.: 11/163,212

(22) Filed: Oct. 10, 2005

Related U.S. Application Data
(63) Continuation-in-part of application No. 10/906,006, filed on Jan. 31, 2005.

(51) Int. Cl. G06F 3/00

(52) U.S. Cl. 710/20

(57) ABSTRACT

A digital television (DTV) system comprises a front-end circuit comprises a demodulator circuit for producing a non-decrypted transport stream signal; a back-end circuit for decoding transport stream data; an external memory coupled to the back-end circuit; an address bus and a data bus to which the external memory is coupled through a plurality of address and data pins; a cryptocard module coupled to the front-end circuit and the back-end circuit for decrypting transport stream data to produce a decrypted transport stream signal and for performing conditional access and security functions, the cryptocard module having address and data pins coupled to address and data pins of the external memory; and a switching means for providing either the non-decrypted transport stream signal produced by the front-end circuit or the decrypted transport stream signal produced by the cryptocard module to the back-end circuit.

### CROSS REFERENCE TO RELATED APPLICATIONS

This application is a continuation-in-part of applicant's earlier application, Ser. No. 10/906,006, filed Jan. 31, 2005, the entirety of which is incorporated by reference.

### BACKGROUND

The invention relates to an information receiver, and more specifically, to a digital television (DTV) system with address and data pins of a cryptocard module coupled with address and data pins of an external memory for reducing the number of pins used.

In digital cable systems, video/audio content is protected by a conditional access scrambling system. A cryptocard module, such as an Advanced Televisions Systems Committee (ATSC) Point of Deployment (POD) security module (now called CableCARD) or a Digital Video Broadcasting Common Interface (DVB-CI) module, removes the scrambling and may rescramble the video content before delivering it to consumer receivers and set-top terminals (known as host devices) across an interface between the cryptocard module and the host device. The cryptocard security module has a CPU interface to communicate with the CPU of the host device. In addition, host devices often connect to peripherals or to external memories, such as a ROM or flash memory, for CPU instruction or data storage.

Please refer to FIG. 1. FIG. 1 is a block diagram of a conventional DTV system 10. The DTV system 10 comprises a host front-end IC 20, a host back-end IC 30, and a POD module 50. The host front-end IC 20 is connected to a cable connection for processing the video/audio content provided by the cable connection. The host front-end IC 20 comprises a transmit circuit 24 and a receive circuit 26 for communicating with an out-of-band port of the POD module 50. The video/audio content is also received by a tuner circuit 22 and passed to a demodulator circuit 28. The demodulator circuit 28 removes a carrier frequency of the video signal and transmits the result directly to a demultiplexer 32 of the host back-end IC 30 through a first transport stream port TS1 and to an inband port of the POD module 50. The POD module 50 descrambles video signals and provides the descrambled video stream to the demultiplexer 32 through a second transport stream port TS2.

The host back-end IC 30 contains a POD CPU interface 34 for communicating address and data information with the POD module 50 through a CPU interface of the POD module 50. An external memory interface 36 of the host back-end IC 30 is used for communicating with external memory and peripheral devices through an address and data bus 45. The external memory is used for storing instructions or data for the host back-end IC 30. As shown in FIG. 1, the external memory interface 36 communicates with a flash memory 40, a read-only memory (ROM) 42, and peripheral devices 44.

Unfortunately, the great number of connections between devices in the DTV system 10 requires a high number of pins to be used for connecting the devices. For example, even though the POD CPU interface 34 may not interface with the POD module 50 frequently and the external memory interface 36 also may not access the external memory 40, 42 and peripherals 44 frequently, each of these connections still uses its own set of address and data pins in the DTV system 10. Moreover, the demultiplexer 32 uses at least two transport stream ports TS1 and TS2 for receiving transport stream data. Each of these transport stream ports TS1 and TS2 requires multiple pins to be used, and also increases the overall use of pins on the host back-end IC 30. Using a large number of pins increases the cost of manufacturing the host back-end IC 30, increases the footprint of the host back-end IC 30, and makes designing the host back-end IC 30 more difficult.

### SUMMARY OF THE INVENTION

A digital television system is provided. An exemplary embodiment of a DTV system is disclosed. The DTV system comprises a front-end circuit comprising a demodulator circuit for producing a non-decrypted transport stream signal; a back-end circuit for decoding transport stream data; an external memory coupled to the back-end circuit; an address bus and a data bus to which the external memory is coupled through a plurality of address and data pins; a cryptocard module coupled to the front-end circuit and the back-end circuit for decrypting transport stream data to produce a decrypted transport stream signal and for performing conditional access and security functions, the cryptocard module having address and data pins coupled to address and data pins of the external memory; and a switching means for providing either the non-decrypted transport stream signal produced by the front-end circuit or the decrypted transport stream signal produced by the cryptocard module to the back-end circuit.

Another exemplary embodiment of a DTV system is disclosed. The DTV system comprises a front-end circuit comprising an input for receiving audio/video data in the form of an out-of-band transport stream signal and a demodulator circuit for producing an inband transport stream signal; a back-end circuit for decoding transport stream data; an external memory coupled to the back-end circuit; an address bus and a data bus to which the external memory is coupled through a plurality of address and data pins; a cryptocard module for performing conditional access and security functions, the cryptocard module having address and data pins coupled to address and data pins of the external memory; and a switching means for providing either the out-of-band transport stream signal or the inband transport stream signal produced by the front-end circuit to the back-end circuit.

### BRIEF DESCRIPTION OF THE DRAWINGS

FIG. 1 is a block diagram of a conventional DTV system.

FIG. 2 is a functional block diagram of a DTV system according to a first exemplary embodiment.

FIG. 3 is a diagram showing the plurality of multiplexers used to select between available input signals.

FIG. 4 is a functional block diagram of a DTV system according to a second exemplary embodiment.

### DETAILED DESCRIPTION

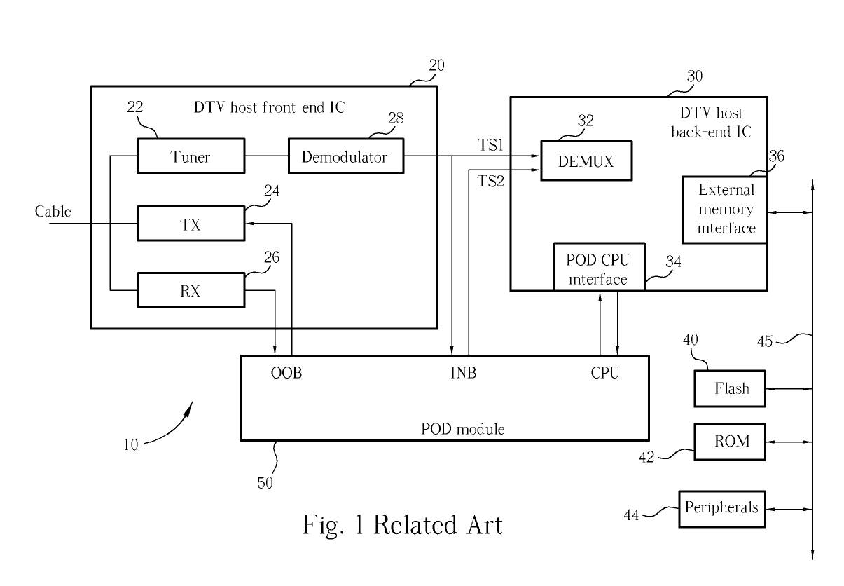

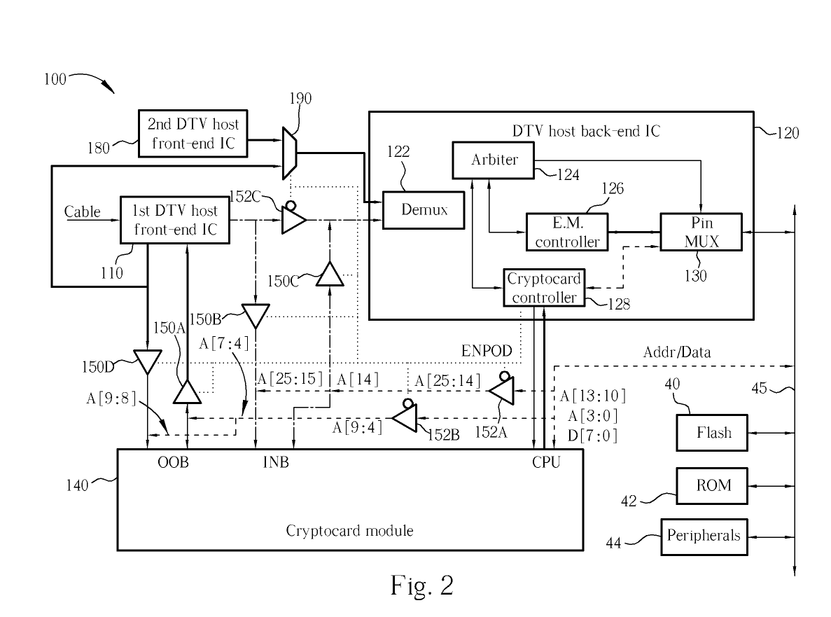

Please refer to FIG. 2. FIG. 2 is a functional block diagram of an exemplary embodiment of an information receiver such as DTV system 100. Like the DTV system 10 shown in FIG. 1, the DTV system 100 contains a first host front-end IC 110, a host back-end IC 120, and a cryptocard module 140. The first host front-end IC 110 can be the same or similar to the host front-end IC 20 of FIG. 1, and contains at least a demodulator circuit for removing a carrier frequency of the video signal received from a cable connection.

The cryptocard module 140 contains a CPU interface for communicating with the host back-end IC 120. The CPU interface of the cryptocard module 140 transmits data signals, address signals, and control signals. Since the host back-end IC 120 may only infrequently access the cryptocard module 140, the external memories 40, 42 and the peripherals 44, it is possible to share the address and data buses among the cryptocard module 140, the external memories 40, 42 and the peripherals 44.

Like the host back-end IC 30 shown FIG. 1, the host back-end IC 120 also contains a demultiplexer 122 which demultiplexes audio/video data and decodes transport stream layer information from the first host front-end IC 110 and the cryptocard module 140. Unlike the host back-end IC 30, however, the host back-end IC 120 contains a cryptocard controller 128, an external memory controller 126, a pin multiplexer 130, and an arbiter 124. The cryptocard controller 128 controls access to the cryptocard module 140 and the external memory controller 126 controls access to the memories 40, 42 and the peripherals 44. When the cryptocard controller 128 or the external memory controller 126 wants to access the address and data bus 45, they request access from the arbiter 124. The arbiter 124 then determines which of the cryptocard controller 128 and the external memory controller 126 has the right to access the address and data bus 45, and controls the pin multiplexer 130 to select address or data from either the cryptocard controller 128 or the external memory controller 126.

The cryptocard module 140 can be utilized in either a first (POD) mode or in a second (PCMCIA) mode. Initially, the cryptocard module 140 will be in PCMCIA mode for allowing the host back-end IC 120 to access the cryptocard module 140, the external memories 40, 42 and peripherals 44 through the shared address and data pins by means of pin arbitration. After the host back-end IC 120 sets cryptocard module 140 to be in POD mode, some of the PCMCIA address pins, such as A4-A9 and A14-A25 are used to carry transport stream data, conditional access messages, or network management messages of the DTV system 100. In order for the same address pins to be utilized in both POD mode and in PCMCIA mode, tri-state buffers 150A-150D and 152A-152C are added to the DTV system 100, and a control signal ENPOD is used for controlling these tri-states buffers. When the control signal ENPOD has a value of logical “1”, the active-high tri-state buffers 150A-150D are in an enabled state and the active-low tri-state buffers 152A-152C are in a high-impedance state, and vice versa.

When the cryptocard module 140 is in PCMCIA mode, the control signal ENPOD has a value of logical “0”, and the address pins A0-A25 and the data pins D0-D7 of the address and data bus 45 can be shared with the external memories 40, 42 and the peripherals 44. When the cryptocard module 140 is in POD mode, the control signal ENPOD has a value of logical “1”, and some of the address pins, A4-A9 and A14-A25, are separated from the external memory address bus. In FIG. 2-FIG. 5, the dashed lines such as the line connecting the address and data bus 45 and the CPU port of the cryptocard module 140 indicate signal paths used when the cryptocard module 140 is in PCMCIA mode; the dotted and dashed lines such as the line connecting the first host front-end IC 110 and the inband port of the cryptocard module 140 indicate signal paths used when the cryptocard module 140 is in POD mode; and the dotted lines indicate the path of the control signal ENPOD.

When the cryptocard module 140 is in PCMCIA mode, the demultiplexer 122 receives the transport stream from the demodulator of the first host front-end IC 110 directly. When the cryptocard module 140 is in POD mode, the demultiplexer 122 receives the transport stream from the cryptocard module 140. The tri-state buffers 150A-150D and 152A-152C are used to control the flow of the transport stream. Please note that the tri-state buffers 150A-150D and 152A-152C can also be replaced with switches, multiplexers, or other similar controllable devices.

The DTV system 100 shown in FIG. 2 is an example of a system conforming to the Advanced Televisions Systems Committee (ATSC) standards. Please note, that the DTV system 100 can also be adapted for the Digital Video Broadcasting standards. Therefore, the cryptocard module 140 is either an ATSC compliant POD/CableCARD module or a DVB compliant Common Interface module, for performing conditional access and security functions that allow selective access to digital cable services.

When out-of-band control signals sent from the first host front-end IC 110 to the cryptocard module 140 through the tri-state buffer 150D are packetized as transport stream packets, the out-of-band control signals can be sent to the demultiplexer 122 for processing the out-of-band control signals. The out-of-band control signals may include different kinds of MPEG sections such as program guide tables, system information tables, and cryptocard tables containing signals such as EMM, ECM, PAT, and PMT. Instead of using the CPU interface to demultiplex different MPEG sections and to do version control, the DTV system 100 can instead send these MPEG sections to the demultiplexer 122 since the demultiplexer 122 already has built-in section filtering hardware for processing these MPEG sections. In addition, since these out-of-band control signals are likely packetized in the form of a transport stream, the out-of-band control signals can be multiplexed with another transport stream coming from a second host front-end IC 180. The second host front-end IC 180 may be identical to the first host front-end IC 110 and can optionally be used for providing another transport stream to be sent to the host back-end IC 120. For example, the second host front-end IC 180 could be used for displaying a second set of image data in picture-in-picture (PIP) mode or picture-outside-picture (POP) mode.

If the second host front-end IC 180 is to be used, one or more multiplexers 190 can provide a means for switching between the out-of-band control signal transport stream sent from the first host front-end IC 110 and the transport stream output from the second host front-end IC 180. Although a multiplexer 190 is shown in the preferred embodiment, other switching devices such as tri-state buffers or various types of switches can also be used instead. In this example, the multiplexer 190 is controlled by the same control signal ENPOD that is used for controlling the tri-state buffers 150A-150D and 152A-152C.

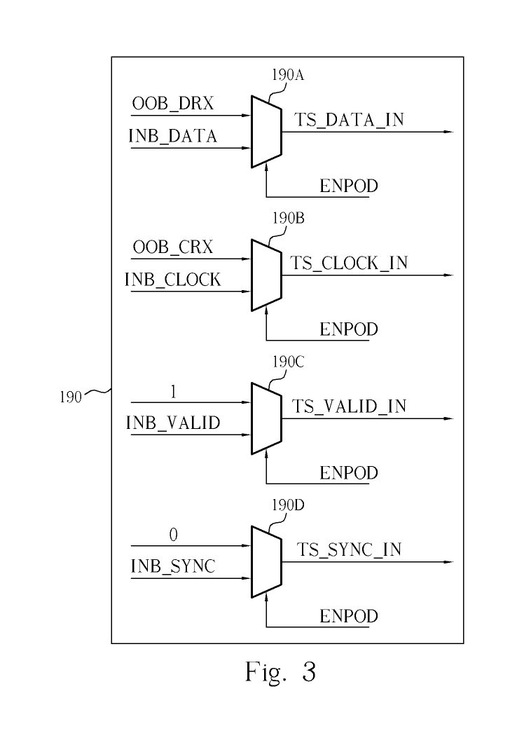

Please refer to FIG. 3. FIG. 3 is a diagram showing the plurality of multiplexers 190 used to select between available input signals. Multiplexer 190A is used to select between the out-of-band control signal DRX and the inband data signal DATA. The data signal can either be transmitted in serial or in parallel. Multiplexer 190B is used to select between the out-of-band control signal CRX and the inband clock signal CLOCK. Multiplexers 190C and 190D are optionally used to transmit an inband valid indicator VALID and an inband sync signal SYNC, respectively. If used, then multiplexer 190C selects between the default value of “1” and the inband valid indicator VALID, and multiplexer 190D is used to select between the default value of “0” and the inband sync signal SYNC.

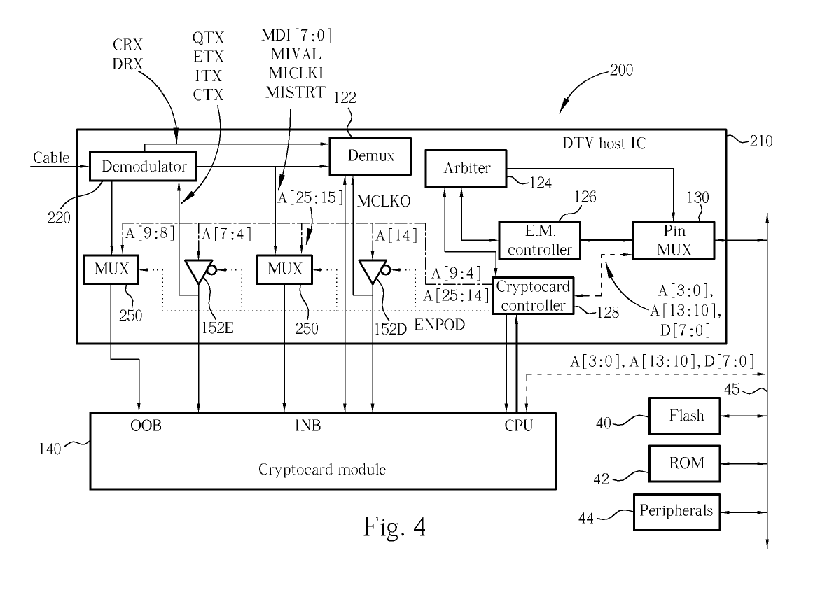

Please refer to FIG. 4. FIG. 4 is a functional block diagram of an exemplary embodiment of an information receiver such as DTV system 200. The DTV system 200 is a single chip solution having a host IC 210 in the form of a single IC instead of using separate front-end and back-end ICs. For optimizing the number of pins that are required, the cryptocard controller 128 shares address pins A0-A3 and A10-A13 and data pins D0-D7 with the external memories 40, 42 and peripherals 44. The cryptocard controller 128 shares pins of address signals A15-25 with the signals MDI0-7, MIVAL, MICLKI, MISTRT to be sent from a demodulator 220 of the host IC 210 to the inband port of the cryptocard module 140. The control signal ENPOD controls a multiplexer 250 to select the appropriate set of signals. Similarly, pins used for address signals A8-A9 are shared with out-of-band signals DRX and CRX and selected by the use of another multiplexer 250. The control signal ENPOD also controls the flow of address signals Al 4 and A4-A7 along with inband signal MCLKO and out-of-band signals QTX, ETX, ITX, CTX through the use of tri-state buffers 152D and 152E. In addition, the out-of-band control signals CRX and DRX are sent from the demodulator 220 to the demultiplexer 122 for taking advantage of the ability of the demultiplexer 122 to process these signals.

In contrast to the conventional DTV system, in the two embodiments described above, address and data pins of the cryptocard module are coupled to address and data pins of the external memory for reducing the total number of pins used on the back-end circuit. Reducing the number of pins on the back-end circuit reduces the footprint of the back-end circuit and lowers the cost needed to manufacture the back-end circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A digital television (DTV) system, comprising:
a front-end circuit comprising a demodulator circuit for producing a non-decrypted transport stream signal;
a back-end circuit for decoding transport stream data;
an external memory coupled to the back-end circuit;
an address bus and a data bus to which the external memory is coupled through a plurality of address and data pins;
a cryptocard module coupled to the front-end circuit and the back-end circuit for decrypting transport stream data to produce a decrypted transport stream signal and for performing conditional access and security functions, the cryptocard module having address and data pins coupled to address and data pins of the external memory; and
a switching means for providing either the non-decrypted transport stream signal produced by the front-end circuit or the decrypted transport stream signal produced by the cryptocard module to the back-end circuit.

2. The system of claim 1, wherein the switching means switches the address and data pins of the cryptocard module between a first mode and a second mode, and the back-end circuit comprises a cryptocard module controller generating a control signal coupled to the switching means for switching the cryptocard module between the first mode and the second mode.

3. The system of claim 2, wherein the switching means comprises at least a tri-state buffer controlled by the control signal generated by the cryptocard module controller, the control signal switching the tri-state buffers between an enabled state and a high-impedance state for switching the cryptocard module between the first mode and the second mode.

4. The system of claim 2, wherein the switching means comprises at least a switch controlled by the control signal generated by the cryptocard module controller for switching the cryptocard module between the first mode and the second mode.

5. The system of claim 2, wherein the switching means comprises at least a multiplexer controlled by the control signal generated by the cryptocard module controller for switching the cryptocard module between the first mode and the second mode.

6. The system of claim 2, wherein the back-end circuit further comprises:
an external memory controller;
a pin multiplexer for coupling either the cryptocard module controller or the external memory controller to the address bus and the data bus; and
an arbiter coupled to the cryptocard module controller and the external memory controller, the arbiter receiving requests from the cryptocard module controller and the external memory controller for access to the address bus and the data bus, and granting access by controlling operation of the pin multiplexer.

7. The system of claim 1, wherein the cryptocard module is an Advanced Televisions Systems Committee (ATSC) compliant Point of Deployment (POD)/CableCARD module.

8. The system of claim 1, wherein the cryptocard module is a Digital Video Broadcasting Common Interface (DVB-CI) module.

9. A digital television (DTV) system, comprising:
a front-end circuit comprising:
an input for receiving audio/video data in the form of an out-of-band transport stream signal; and
a demodulator circuit for producing an inband transport stream signal;
a back-end circuit for decoding transport stream data;
an external memory coupled to the back-end circuit;
an address bus and a data bus to which the external memory is coupled through a plurality of address and data pins;
a cryptocard module for performing conditional access and security functions, the cryptocard module having address and data pins coupled to address and data pins of the external memory; and
a switching means for providing either the out-of-band transport stream signal or the inband transport stream signal produced by the front-end circuit to the back-end circuit.

10. The system of claim 9, wherein the switching means switches the address and data pins of the cryptocard module between a first mode and a second mode, and the back-end circuit comprises a cryptocard module controller generating a control signal coupled to the switching means for switching the cryptocard module between the first mode and the second mode.

11. The system of claim 10, wherein the switching means comprises at lease a tri-state buffer controlled by the control signal generated by the cryptocard module controller, the control signal switching the tri-state buffers between an enabled state and a high-impedance state for switching the cryptocard module between the first mode and the second mode.

12. The system of claim 10, wherein the switching means comprises at least a switch controlled by the control signal generated by the cryptocard module controller for switching the cryptocard module between the first mode and the second mode.

13. The system of claim 10, wherein the switching means comprises at least a multiplexer controlled by the control signal generated by the cryptocard module controller for switching the cryptocard module between the first mode and the second mode.

14. The system of claim 10, wherein the back-end circuit further comprises:
an external memory controller;
a pin multiplexer for coupling either the cryptocard module controller or the external memory controller to the address bus and the data bus; and
an arbiter coupled to the cryptocard module controller and the external memory controller, the arbiter receiving requests from the cryptocard module controller and the external memory controller for access to the address bus and the data bus, and granting access by controlling operation of the pin multiplexer.

15. The system of claim 9, wherein the cryptocard module is an Advanced Televisions Systems Committee (ATSC) compliant Point of Deployment (POD)/CableCARD module.

16. The system of claim 9, wherein the cryptocard module is a Digital Video Broadcasting Common Interface (DVB-CI) module.
